(19) United States
(12) Patent Application Publication
(10) Pub. No.: US 2026/0077525 A1
(43) Pub. Date: Mar. 19, 2026

(54) ICE AXE COVER

(71) Applicant: Andrew Hughes, Seattle, WA (US)

(72) Inventor: Andrew Hughes, Seattle, WA (US)

(21) Appl. No.: 19/329,545

(22) Filed: Sep. 15, 2025

Related U.S. Application Data
(60) Provisional application No. 63/694,554, filed on Sep. 13, 2024.

(51) Int. Cl. B26B 29/00; A45B 3/00; A63B 29/08; B25F 1/00

(52) U.S. Cl. CPC B26B 29/00; A45B 3/00; A63B 29/08; B25F 1/006

(57) ABSTRACT

An ice axe cover comprises a head section configured to cover at least a portion of a head of an ice axe. The head section comprises an adze slot for receiving an adze of the ice axe and a pick sleeve for receiving a pick of the ice axe. In some embodiments, at least a cutting edge of the adze is exposed outside the adze slot, and at least a tip of the pick is exposed outside the pick sleeve. The ice axe cover can also comprise a shaft section that covers at least some of a shaft of the ice axe. The shaft section can extend from a shaft junction between the pick sleeve and adze slot of the head section. The ice axe cover can comprise a thermally insulative material, such as neoprene, a grip component, and a reflective component.

### CROSS-REFERENCE TO RELATED APPLICATIONS

The present application claims priority to and the benefit of U.S. Provisional Ser. No. 63/694,554 , filed Sep. 13, 2024, entitled “ICE AXE COVER,” the disclosure of which is incorporated herein by reference in its entirety.

### BACKGROUND

Mountaineering is an inherently dangerous activity. Even the least treacherous of mountains are fraught with risks. Those risks do not keep willing adventurers away. Indeed, daring mountaineers ascend the highest peaks on earth, where they traverse uncertain terrain in low oxygen and freezing conditions.

Mountaineers rely on their equipment to survive these hazardous environments. Although the risks involved cannot be eliminated, they can be reduced by technology.

Among a mountaineer's most important gear is an ice axe. Useful most simply as a walking stick, an ice axe can also be used to self-arrest in the event of a slip downhill, embed in snow or ice for security and to aid traction, anchor a rope for securing a climber or to act as a stomp belay, or cut footholds in ice or scoop compacted snow. For a mountaineer, an ice axe is an essential and a potentially life-saving tool.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A standard ice axe consists of a head comprising a pick and an adze on opposing sides, a shaft extending from the head, and a spike at an end of the shaft opposite the head. Optionally, an ice axe head can also include a leash hole, through which a leash or carabiner can be attached.

The head, including the pick and adze, is typically made of steel or another durable metal. A mountaineer using the ice axe as a walking stick can use the head as a handle.

The pick is a toothed pointed end of the head. The pick is typically curved to a slight degree. The mountaineer can self-arrest in the event of a slide downhill by jamming the pick of the ice axe into the hill.

The adze is a wide end of the head. The adze can be used as a tool for, among other things, chopping steps in hard snow and ice.

The shaft extends from the head of the ice axe, from between the pick and the adze. The shaft can be straight or slightly angled. The shaft is typically composed of a lightweight metal, such as aluminum or titanium, or a composite.

The spike is a point at the base of the shaft, used for balance and safety when the ice axe is held by its head in a walking stick fashion. The spike can penetrate snow and ice when pressure is applied by a mountaineer via the head. A mountaineer can use the ice axe as an anchor by burying the shaft, first by the spike, up to the head of the ice axe.

Mountaineers typically carry their ice axe in hand, ensuring that it is available for immediate use. Often the ice axe is held in hand by its head. For instance, when used as a walking stick, the mountaineer will hold the ice axe with its head buried in a palm of a gloved hand, spike side down, to help support their steps. Other times, when not using the ice axe as a walking stick, a mountaineer will hold the ice axe in a ready position so that it can be used in the event of an emergency, such as to self-arrest should the mountaineer slip downhill. In one such common position, a mountaineer holds the ice axe with one hand on the ice axe head and another on its shaft, with the pick side of the head directed toward the mountain. That way, if the mountaineer were to slip, the pick may be quickly jammed into the snowy terrain.

At locations of high elevation and elsewhere where mountaineers explore, the environment is often frigid, with temperatures sometimes falling below −30 Celsius. Even while wearing insulative gloves and using hand warmers, a mountaineer's hands and fingers will become dangerously cold in these environments. To make matters worse, a temperature of an ice axe will approach the temperature of the environment in which the ice axe is used. The head of the ice axe, composed of steel or another metal, acts as a heat sink for the mountaineer's hand. Consequently, a cold ice axe, even held by a gloved hand, can increase the risk that a mountaineer experiences frostbite on the hand during an expedition. Frostbite is a direct danger, as it can permanently damage tissue. It can also increase the risk of more terrible events on a mountain as a mountaineer loses full use of their hands.

Several embodiments of the disclosed technology can thermally insulate a hand that is either gloved or bare from a head of an ice axe held by the hand. Several embodiments of the disclosed technology can reduce heat loss from a mountaineer's hand to an ice axe without sacrificing functionality of the ice axe. Several embodiments of the disclosed technology can help a mountaineer grip an ice axe. Several embodiments of the disclosed technology can help a mountaineer visually locate an ice axe in visually compromised conditions, such as in the dark or during a storm.

According to embodiments of the disclosed technology, an ice axe cover comprises a head section that is configured to cover at least a portion of a head of an ice axe. The head section comprises at least an adze slot for receiving an adze and a pick sleeve for receiving a pick of the ice axe. In some embodiments, the ice axe cover is configured so that at least a cutting edge of the adze is exposed outside the adze slot and at least a tip of the pick is exposed outside the pick sleeve when the ice axe cover is attached to an ice axe. The ice axe cover can also comprise a shaft section that covers at least some of a shaft of the ice axe. The shaft section can extend from a shaft junction between the pick sleeve and adze slot. The ice axe cover can comprise a thermally insulative material, such as neoprene. Accordingly, the ice axe cover, when attached to an ice axe, can thermally insulate a hand of a person from areas of the ice axe held by the hand.

In some embodiments, the ice axe cover comprises a grip component configured to improve a grip by a hand, or a gloved hand, of an ice axe covered by the ice axe cover. In some embodiments, the ice axe cover comprises a reflective component configured on an outer surface of the ice axe cover. For example, in some embodiments, the reflective component can comprise a retroreflective coating. In some embodiments, the ice axe cover can be easily attached to and removed from an ice axe. For example, in some embodiments, the adze slot comprises an adze attachment component and the shaft section comprises a shaft attachment component, and the adze attachment component and the shaft attachment component can each be easily engaged and disengaged, enabling the ice axe cover to be attached to and removed from an ice axe with ease. In some embodiments, the adze attachment component and the shaft attachment component respectively comprise hook-and-loop fasteners.

A benefit of the disclosed technology is that it reduces risk of injury to a mountaineer's hands associated with cold environmental temperatures while mountaineering. Another benefit of the disclosed technology is it improves safety of using an ice axe without compromising functionality of the ice axe. Another benefit of the disclosed technology is that it can improve grip of an ice axe in a hand of a mountaineer. Another benefit of the disclosed technology is that it can improve the likelihood that a misplaced or lost ice axe can be found in visually compromised conditions, such as in the dark. Another benefit of the disclosed technology is that it can be applied to or removed from an ice axe easily. Another benefit of the disclosed technology is it can improve the safety of using an ice axe as a walking stick. Another benefit of the disclosed technology is that it can make a mountaineer's ice axe, and therefore the mountaineer, more conspicuous to other mountaineers.

### BRIEF DESCRIPTION OF THE DRAWINGS

FIG. 1 is a schematic perspective view of an ice axe cover attached to an ice axe, in accordance with embodiments of the disclosed technology.

FIG. 2 is a schematic perspective view of the ice axe cover attached to the ice axe, in accordance with embodiments of the disclosed technology.

FIG. 3 is a schematic perspective view of the ice axe cover in accordance with embodiments of the disclosed technology.

FIG. 4 is a schematic left side view of the ice axe cover in accordance with embodiments of the disclosed technology.

FIG. 5 is a schematic right side view of the ice axe cover in accordance with embodiments of the disclosed technology.

FIG. 6 is a schematic front view of the ice axe cover in accordance with embodiments of the disclosed technology.

FIG. 7 is a schematic back view of the ice axe cover in accordance with embodiments of the disclosed technology.

FIG. 8 is a schematic top view of the ice axe cover in accordance with embodiments of the disclosed technology.

FIG. 9 is a schematic bottom view of the ice axe cover in accordance with embodiments of the disclosed technology.

FIG. 10 is a schematic left side view of an ice axe cover in accordance with embodiments of the disclosed technology.

FIG. 11 is a schematic right side view of the ice axe cover in accordance with embodiments of the disclosed technology.

### DETAILED DESCRIPTION

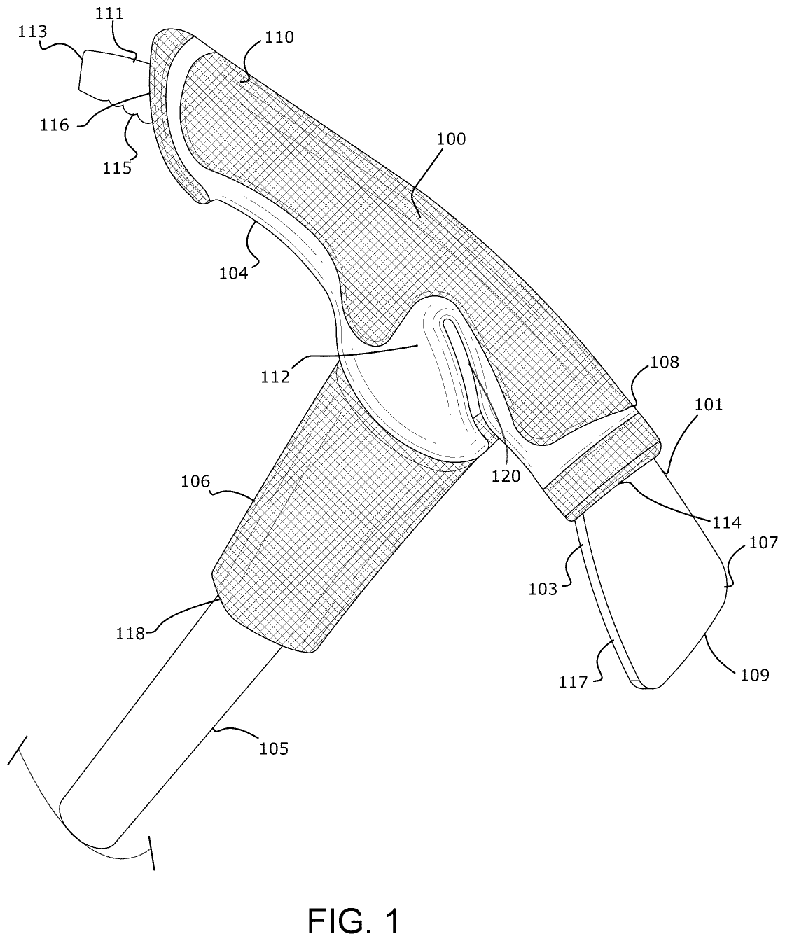

Certain embodiments of ice axe covers, ice axes including ice axe covers, and associated methods of use and manufacture, including apparatuses, articles of manufacture, systems, devices, components, and modules thereof, for covering at least part of a head of an ice axe, are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-11.

FIG. 1 is a schematic perspective view of an ice axe cover 100, shown attached to and covering at least a portion of an ice axe 101, in accordance with embodiments of the disclosed technology. As shown in FIG. 1, the ice axe cover 100 can comprise a head section 104 and a shaft section 106. The head section 104 is configured to cover at least a portion of a head 103 of the ice axe 101, and the shaft section 106 is configured to cover at least a portion of a shaft 105 of the ice axe 101. The ice axe shown in FIG. 1 is cut off partway down its shaft for clarity.

The head section 104 comprises an adze slot 108 and a pick sleeve 110. The adze slot 108 extends from a shaft junction 112 of the head section 104 of the ice axe cover 100 to an adze slot opening 114 of the ice axe cover 100. The adze slot 108 is configured to cover at least a portion of an adze 107 of the head 103 of the ice axe 101. The adze slot 108 is configured to expose, via the adze slot opening 114, at least some of the adze 107 outside the head section 104 of the ice axe cover 100. The adze slot 108 is configured to expose outside the head section 104 of the ice axe cover 100 at least a cutting edge 109 of the adze 107 of the ice axe 101. In some embodiments, as shown in FIG. 1, the adze slot 108 can be configured to expose outside the ice axe cover 100 at least a majority of a blade 117 of the adze 107.

The pick sleeve 110 extends from the shaft junction 112 of the head section 104 of the ice axe cover 100 to a pick sleeve opening 116. The pick sleeve 110 is configured to cover at least a portion of a pick 111 of the head 103 of the ice axe 101. The pick sleeve is configured to expose outside the head section 104 of the ice axe cover 100 at least a pick tip 113 of the pick 111. In some embodiments, the pick sleeve 110 is configured to expose outside the head section 104 at least one tooth 115 of the pick 111.

The shaft section 106 is configured to cover at least a portion of the shaft 105 of the ice axe 101. The shaft section 106 can be configured to extend from the shaft junction 112 to a shaft opening 118 of the ice axe cover 100. The shaft junction 112 can be configured to cover at least a junction (not shown) of the head 103 and the shaft 105 of the ice axe 101. In some implementations, as shown in FIG. 1, the shaft junction 112 of the ice axe cover 100 can comprise a leash notch 120, which can provide access to a leash hole (not shown), carabiner hole (not shown), or the like, of the ice axe 101. For example, in such an embodiment, a leash (not shown) can be attached to the ice axe 101 via a leash hole (not shown) accessed through the leash notch 120 of the ice axe cover 100. In some embodiments, as shown in FIG. 1, the leash notch is configured, at least in part, between the adze slot 108 of the head section 104 and the shaft section 106 at the shaft junction 112 of the ice axe cover 100.

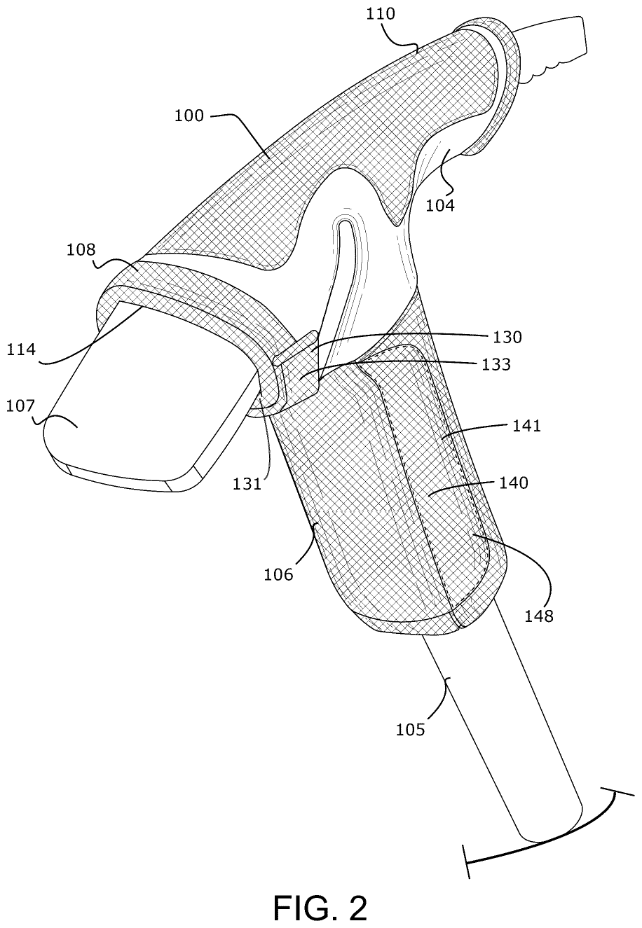

FIG. 2 is a schematic perspective back left view of the ice axe cover 100, shown attached to the ice axe 101, in accordance with embodiments of the disclosure. The ice axe cover 100 includes the adze slot 108 and adze slot opening 114, the shaft section 106, and the pick sleeve 110. The shaft section 106 comprises a shaft attachment component 140, which is shown engaged in FIG. 2, thereby releasably attaching the ice axe cover 100 to the ice axe 101 via the shaft 105. The ice axe shown in FIG. 2 is cut off partway down its shaft for clarity.

In some embodiments, the ice axe cover 100 also comprises an attachment component on the head section 104. For example, as shown in FIG. 2, in some embodiments, the ice axe cover 100 can comprise an adze attachment component 130 configured on the adze slot 108. FIG. 2 shows the adze attachment component 130 engaged, thereby releasably attaching the ice axe cover 100 to the ice axe 100 via the adze 107 of the ice axe 101.

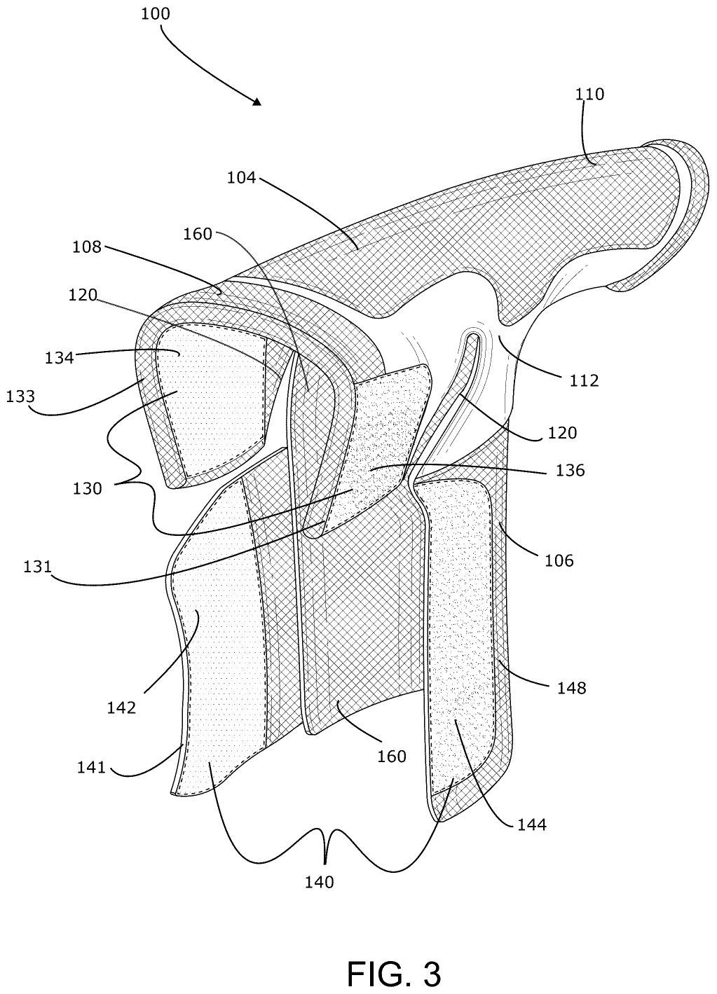

FIG. 3 is a schematic back left perspective view of the ice axe cover 100 in accordance with embodiments of the disclosure. The ice axe cover 100 shown in FIG. 3 is not covering an ice axe (not shown), and the shaft attachment component 140 and the adze attachment component 130 are respectively not engaged.

As shown in FIG. 3, in some embodiments, the ice axe cover 100 comprises a body component 160. As discussed in further detail herein, the body component 160 can comprise a thermally insulative material. As shown in FIG. 3, in some embodiments, the head section 104, including the adze slot 108 and pick sleeve 110, and the shaft section 106, comprise the body component 160.

The adze slot 108 includes the adze attachment component 130 that is configured to releasably attach the adze slot 108 to an adze of an ice axe (not shown), and, consequently, the ice axe cover 100, to the ice axe (not shown). FIG. 3 shows the adze attachment component 130 disengaged. FIGS. 1 and 2 show ice axe cover 100 on the ice axe 101 and the adze attachment component 130 engaged, thereby securing the ice axe cover 100 to the ice axe 101 via the adze 107 of the ice axe (FIGS. 1 and 2).

In some embodiments, the adze slot 108 can comprise a first adze flap 131 and a second adze flap 133. In some embodiments, as shown in FIG. 3, the first adze flap 131 and the second adze flap 133 comprise the adze attachment component 130. In some embodiments, as shown in FIG. 3, the first adze flap 131 and the second adze flap 133 are defined, at least in part, by the leash notch 120. For example, as shown in FIG. 3, the leash notch 120 can be configured to define the first adze flap 131 and second adze flap 133, extending toward the shaft junction 112 on both left and right sides of the ice axe cover 100.

In some embodiments, as shown in FIG. 3, the adze slot 108 comprises a flexible material. For example, in some embodiments, the adze slot 108, including the first adze flap 131 and the second adze flap 133, comprises the body component 160, comprising a flexible insulative material. In some implementations, the first adze flap 131 is configured to fold under an adze of an ice axe (not shown) and the second adze flap 133 is configured to fold under the first adze flap 131 and releasably attach to the first adze flap 131 via the adze attachment component 130, thereby engaging the adze attachment component 130 and releasably securing the ice axe cover 100 to the ice axe (not shown). FIGS. 1 and 2 show the adze attachment component 130 engaged, with the first adze flap 131 and second adze flap 133 folded under the adze 103 of the ice axe 101, releasably attached to one another.

In some embodiments, as shown in FIG. 3, the adze attachment component 130 can comprise a hook-and-loop fastener (e.g., corresponding Velcro™ patches) that is attached to the body component 160. For example, the adze attachment component 130 shown in FIG. 3 includes an adze attachment hook component 134 configured on the second adze flap 133 and an adze attachment loop component 136 configured on the first adze flap 131, which are respectively sewn to the body component 160.

In some embodiments, to engage the adze attachment component 130, the adze attachment hook component 134 can be placed against the adze attachment loop component 136 by folding the first adze flap 131 towards the second adze flap 133, and folding the second adze flap 133 over the first adze flap 131, thereby engaging the adze attachment hook component 134 with the adze attachment loop component 136. When an ice axe (not shown) is placed within the ice axe cover 100 and the adze of the ice axe is placed within the adze slot 108, the adze attachment component 130 can be engaged to releasably attach the ice axe cover 100 to the ice axe via at the adze slot 108.

In other embodiments, the adze attachment component 130 can comprise another attachment mechanism. For example, in some embodiments, the adze attachment component 130 can comprise a buckle. In yet other embodiments, the adze attachment component 130 can comprise a winch device, a zipper, and/or one or more buttons.

In some embodiments, the adze attachment component 130 is configured to secure the ice axe cover 100 to ice axes having different sizes of adzes. Widths and/or diameters of adzes among different ice axes may vary, and the adze attachment component 130 can be configured to accommodate the different adze sizes. For example, in some embodiments, as shown in Figure, the adze slot 108, including the first adze flap 131 and the second adze flap 133, comprises enough material to accommodate different sizes of adzes, and the adze attachment component 130 can be configured to comprise hook and loop fasteners with respective surface areas for attachment that are great enough of accommodate the different sizes.

As shown in FIG. 3, in some embodiments, the shaft section 106 comprises the shaft attachment component 140. The shaft attachment component 140 is configured to secure the ice axe cover 100 to an ice axe (not shown) via a shaft of the ice axe (not shown). FIG. 2 shows the shaft attachment component 140 engaged while the ice axe cover 100 is over the ice axe 101, thereby securing the ice axe cover 100 to the ice axe 101 via the shaft 105 of the ice axe 101. FIG. 3 shows the shaft attachment component 140 disengaged.

As shown in FIG. 3, in some implementations, the shaft attachment component 140 can comprise a hook-and-loop fastener. In some implementations, the shaft attachment component 140 can comprise a shaft attachment hook component 142 and a shaft attachment loop component 144.

In some embodiments, as shown in FIG. 3, the shaft section 106 can comprise a shaft flap 141 that includes a portion of the shaft attachment component 140. The shaft flap 141 shown in FIG. 3 comprises the shaft attachment hook component 142. In some embodiments, the shaft flap 141 is flexible and configured to fold around at least a portion of the shaft section 106 comprising the shaft attachment loop component 144. For example, to engage the shaft attachment component 140, the shaft flap 141 can be folded over the shaft attachment loop component 144, and the shaft attachment hook component 142 can be placed against the shaft attachment loop component 144, thereby releasably attaching the shaft attachment hook component 142 and the shaft attachment loop component 144. By placing an ice axe (not shown) within the ice axe cover 100, including a shaft of the ice axe (not shown) within the shaft section 106, and engaging the shaft attachment component 140, the ice axe cover 100 can be secured to the ice axe by the shaft section 106 via the shaft of the ice axe (not shown). FIG. 2 shows the shaft attachment component 140 engaged and the ice axe cover 100 releasably attached to the ice axe 101 via the shaft attachment component 140, with the shaft flap 141 folded over at least a portion of the shaft section 106 comprising the shaft attachment loop component.

In some embodiments, the shaft attachment component 140 is sewn and/or bonded to the body component 160 of the ice axe cover 100. For example, as shown in FIG. 3, in some embodiments, the shaft attachment hook component 142 can be sewn and/or bonded to the shaft flap 141, and the shaft flap 141 can be sewn and/or bonded to the body component 160 on the shaft section 106, and the shaft attachment loop component 144 can be sewn to the body component 160 on the shaft section 106 of the ice axe cover 100.

In some embodiments, the shaft flap 141 does not comprise the body component 160 where the shaft flap 141 folds over the shaft section 106. For example, in some embodiments, as shown in FIG. 3, the shaft section 106 comprises a layer of grip material on its outer surface, sewn and/or bonded to the body component 160. The layer of grip material can be bonded over a portion of its surface and can comprise the shaft attachment hook component 142 sewn and/or bonded to the grip material comprising the shaft flap 141. By having the portion of the shaft flap 141 that folds over the shaft section 106 not include the body component 160, the shaft section 106 can have a uniform thickness around the shaft of an ice axe (not shown) when covering the ice axe, because a single layer of the body component 160 encircles the shaft.

In other embodiments, the shaft attachment component 140 can comprise another type of fastener. For example, in some embodiments, the shaft attachment component 140 can comprise one or more buckles, a winch, a zipper, and/or one or more buttons.

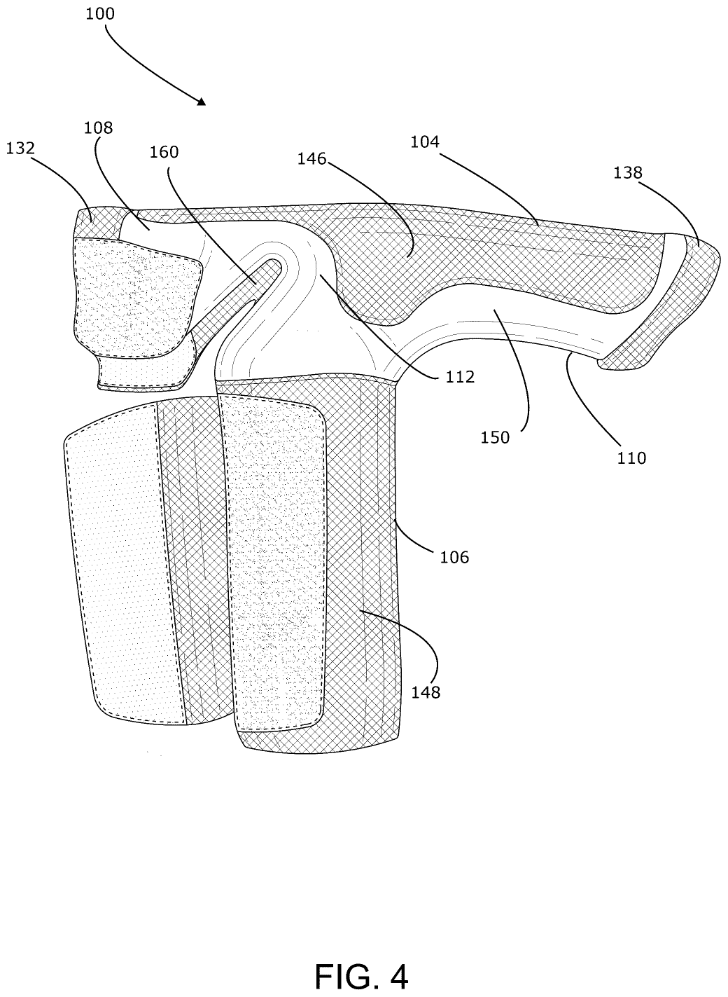

FIG. 4 shows a schematic left side view of the ice axe cover 100 in accordance with embodiments of the disclosure. As shown in FIG. 4, the head section 104 and the shaft section 106 comprise, at least in part, the body component 160. In some embodiments, the body component 160 comprises at least one layer of a thermally insulative material that is patterned and sewn as shown in FIG. 4 and throughout the Figures. In some embodiments, a thermally insulative material comprises a material with an R-Value greater than 2.5. In some embodiments, a thermally insulative material comprises a material with an R-Value between 4 and 6. In some embodiments, a thermally insulative material comprises a material that has an R-Value greater than 6. In some embodiments, the body component comprises a layer of neoprene. In some embodiments, the body component comprises a layer of thermally insulative material that is at least 1 cm thick.

As shown in FIG. 4, the adze slot 108 can comprise an adze slot rim 132 configured on a terminal end of the adze slot 108. In some embodiments, the adze slot rim 132 comprises a durable material that is sewn and/or bonded to the body component 160 at the terminal end of the adze slot 108. The adze slot rim 132 can reinforce an edge of the body component 160 at the adze slot 108, reducing the likelihood that the adze slot 108 rips or is otherwise damaged when a mountaineer uses the adze (not shown) of the ice axe (not shown) that the ice axe cover 100 is covering. In some embodiments, the adze slot rim 132 can comprise a layer of neoprene that includes a tactile component. For example, in some embodiments, the adze slot rim 132 can comprise neoprene that has been configured to comprise a tactile enhanced design, such as raised circular bumps.

As shown in FIG. 4, the pick sleeve 110 can comprise a pick sleeve rim 138 configured on a terminal end of the pick sleeve 110. In some embodiments, the pick sleeve rim 138 can comprise a durable material that is sewn and/or bonded to the body component 160 at the terminal end of the pick sleeve 110. The pick sleeve rim 138 can be configured to reinforce the body component 160 at the pick sleeve 110 to reduce the likelihood that the pick sleeve 110 rips or is otherwise damaged when a mountaineer uses the pick (not shown) of the ice axe (not shown) to that the ice axe cover 100 is covering.

In some embodiments, the body component 160 can comprise a pliable material, and the pick sleeve 110 can be configured to collapse toward the shaft junction 112 when pressure is applied at the pick sleeve rim 138 in a direction of the shaft junction 112. For example, the pick sleeve 110 and the pick sleeve rim 138 can be configured such that when a mountaineer uses a pick of an ice axe (not shown) that the ice axe cover is applied to, such as by jamming the pick into snow and ice, the pick sleeve 110 collapses from its full position toward the shaft junction 112, thereby exposing a greater portion of the pick (not shown) outside of the ice axe cover 100 than was originally exposed.

In some embodiments, the pick sleeve 110 can be configured to collapse when pressure is applied at the pick sleeve rim 138 by configuring the pick sleeve 110 such that it fits semi-loosely over a pick of an ice axe that it is covering. In some embodiments, the pick sleeve 110 can be configured to fit semi-loosely by being constructed such that an internal height and width (or, in other words, internal circumference) of the pick sleeve 110 and the pick sleeve rim 138 are each greater by a collapse margin than a pick height and pick width of an ice axe that the ice axe cover 100 is fastened to. In some embodiments, the collapse margin is at least 10% of the pick height at a location on the pick of the pick sleeve rim 138. As a result of the pick sleeve 110 being collapsible, a mountaineer may retain full use of the pick of an ice axe while the ice axe cover 100 is secured to the ice axe.

In some embodiments, as shown in FIG. 4, the ice axe cover 100 can be configured to comprise a head grip component 146. In some embodiments, the head grip component 146 can comprise a grip layer that is sewn and/or bonded to the body component 160 at the head section 104. The head grip component 146 can comprise a layer patterned to cover at least most of an area of the head section 104 that is opposite the shaft section 106. In some embodiments, the head grip component 146 comprises a layer patterned to cover an entire area of the head section 104. In some embodiments, the head grip component 146 comprises a layer of material that includes a tactile component. For example, in some embodiments, the head grip component 146 can comprise neoprene that has been configured to comprise a tactile enhanced design, such as texture comprising raised circular bumps. In some embodiments, the head grip component 146 comprises a material that is more durable than the body component 160.

In some embodiments, as shown in FIG. 4, the ice axe cover 100 can comprise a shaft grip component 148. In some embodiments, the shaft grip component 148 can comprise a grip layer of material that is sewn and/or bonded to the body component 160 at the shaft section 106. The shaft grip component 148 can comprise a layer of material patterned to cover at least an area of the shaft section 106 below the shaft junction 112. In some embodiments, the shaft grip component 148 comprises a layer of material patterned to cover an entire area of the shaft section 106. In some embodiments, the shaft grip component 148 can comprise a layer of material patterned to cover an area around the shaft section 106 adjacent to the shaft attachment component 140. In some embodiments, as shown in FIG. 2, the shaft attachment component 140 comprises the shaft grip component 148 on an external surface. In some embodiments, the shaft grip component 148 comprises a layer of material that includes a tactile component. For example, in some embodiments, the shaft grip component 148 can comprise neoprene that has been configured to comprise a tactile enhanced design, such as texture comprising raised circular bumps. In some embodiments, the shaft grip component 146 improves the durability of the shaft section 106.

In some embodiments, as shown in FIG. 4, the ice axe cover 100 comprises a dark material on at least a portion of a surface of the ice axe cover 100. One benefit of a dark material on at least a portion of a surface of the ice axe cover 100 is that it visually contrasts with snow and a snowy environment. Accordingly, the ice axe cover 100 may reduce a likelihood that an ice axe to which the ice axe cover 100 is applied may be lost in snow or ice. In some embodiments, as shown in FIG. 4, at least one of the shaft grip component 148, the head grip component 146, the adze slot rim 132, and the pick sleeve rim 138 comprise a dark material.

In some embodiments, as shown in FIG. 4, the ice axe cover 100 can comprise a reflective component 150. The reflective component 150 is configured to reflect light shined at the ice axe cover 100. In some embodiments, the reflective component 150 comprises a coating applied as an external layer to the body component 160 at the head section 104, the shaft section 106, and/or the shaft junction 112. For example, in some embodiments, the reflective component 150 comprises a layer of reflective material that is coated and/or adhered as an outer surface of at least some of the ice axe cover 100.

In some embodiments, the reflective component 150 can be configured such that a portion of the reflective component 150 can be seen from all vantage points of the ice axe cover 100 when it is covering an ice axe. For example, in some embodiments, the reflective component 150 comprises a coating that is patterned on an external surface of the ice axe cover 100 at least in part on the head section 104 opposite the shaft section 106, at least in part on the head section 104 opposite the head grip 146, at least in part on the shaft junction 112 on the left side and right side of the ice axe cover 100, and at least in part on the shaft section 106.

In some embodiments, the reflective component 150 comprises a retroreflective material. For example, in some embodiments, the reflective component 150 comprises 3M™ Scotchlight™ Reflective Material. In some embodiments, the reflective component 150 comprises a material having a diffuse reflection of light in the visible spectrum.

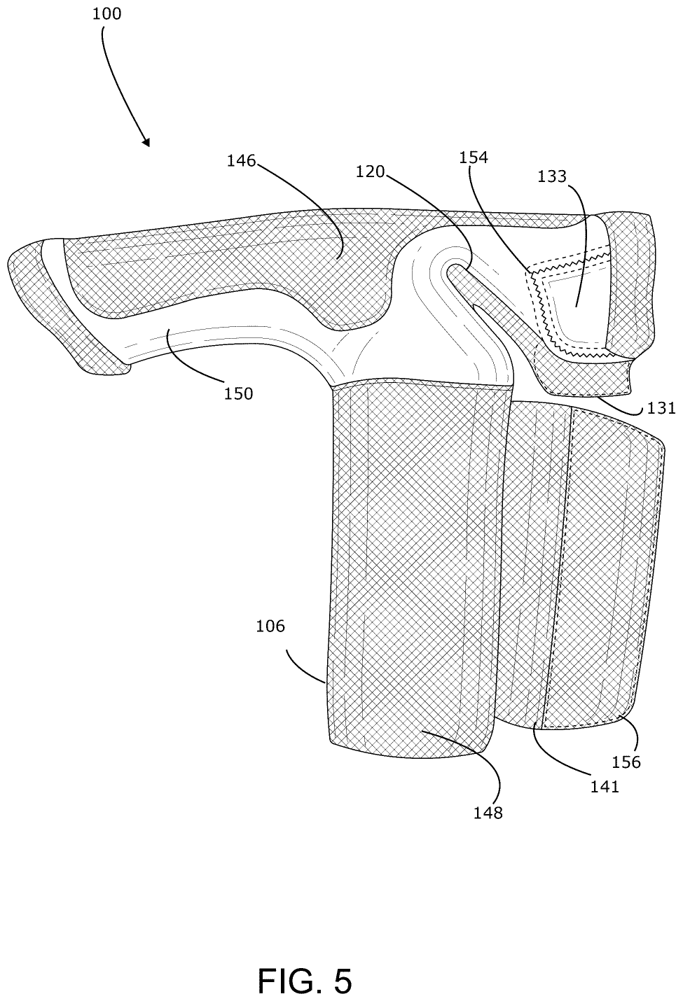

FIG. 5 shows a schematic right side view of the ice axe cover 100 in accordance with embodiments of the disclosure. The ice axe cover 100 comprises the reflective component 150, the head grip component 146, and shaft grip component 148. FIG. 5 also shows the leash notch 120 of the ice axe cover 100.

FIG. 5 shows the first adze flap 131 and the second adze flap 133. The adze attachment component (not shown) is not engaged. FIG. 5 shows the second adze flap 133 comprising adze attachment hook component stitching 154 configured to attach the adze attachment hook component (not shown), which is configured on an opposite side of the second adze flap 133 from the side shown in FIG. 5, to the second adze flap 133.

FIG. 5 also shows the shaft flap 141 configured on the shaft section 106. The shaft attachment component (not shown) is not engaged. The shaft flap 141 comprises shaft attachment hook component stitching 156 configured to attach the shaft attachment hook component (not shown), which is configured on an opposite side of the shaft flap 141 from the side shown in FIG. 5, to the shaft flap 141.

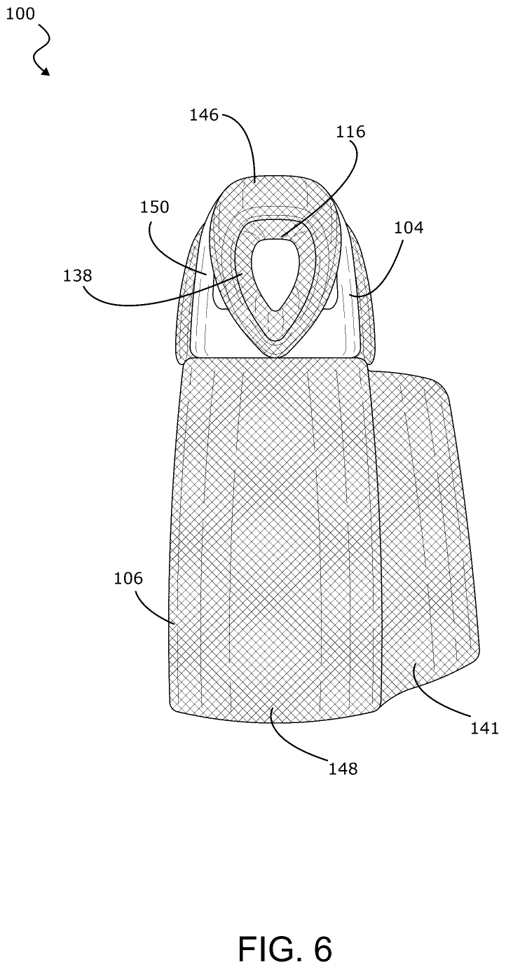

FIG. 6 shows a schematic front view of the ice axe cover 100 in accordance with embodiments of the disclosure. FIG. 6 shows the head section 104, including the head grip component 146, the reflective component 150, and the pick sleeve rim 138 and the pick sleep opening 116. FIG. 6 also shows the shaft section 106, including the shaft grip component 148 and the shaft flap 141.

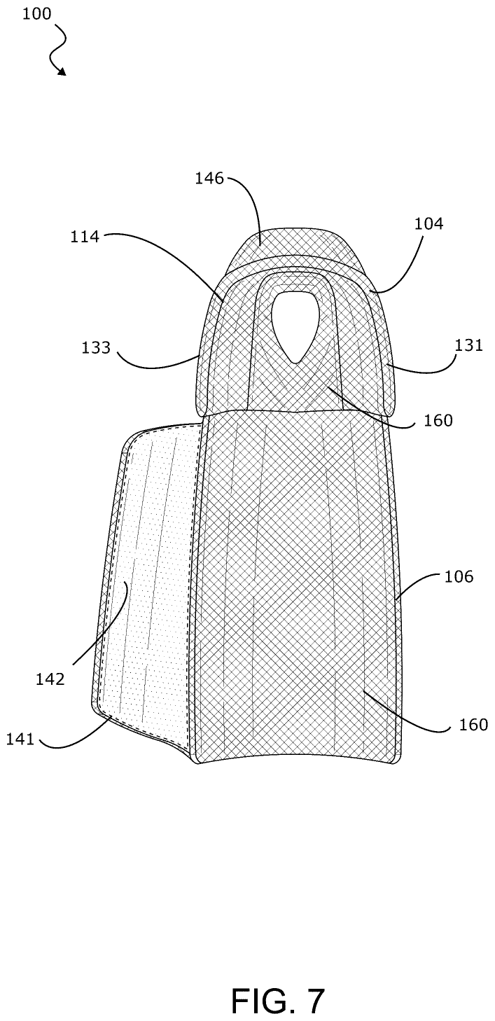

FIG. 7 shows a schematic back view of the ice axe cover 100 in accordance with embodiments of the disclosure. FIG. 7 shows the head section 104, including the first adze flap 131, the second adze flap 133, and the head grip component 146. FIG. 7 also shows the adze slot opening 114. FIG. 7 also shows the shaft section 106, including the shaft flap 141. The shaft flap 141 includes the shaft attachment hook component 142. As shown in FIG. 7, the head section 104 and the shaft section 106 both comprise the body component 160.

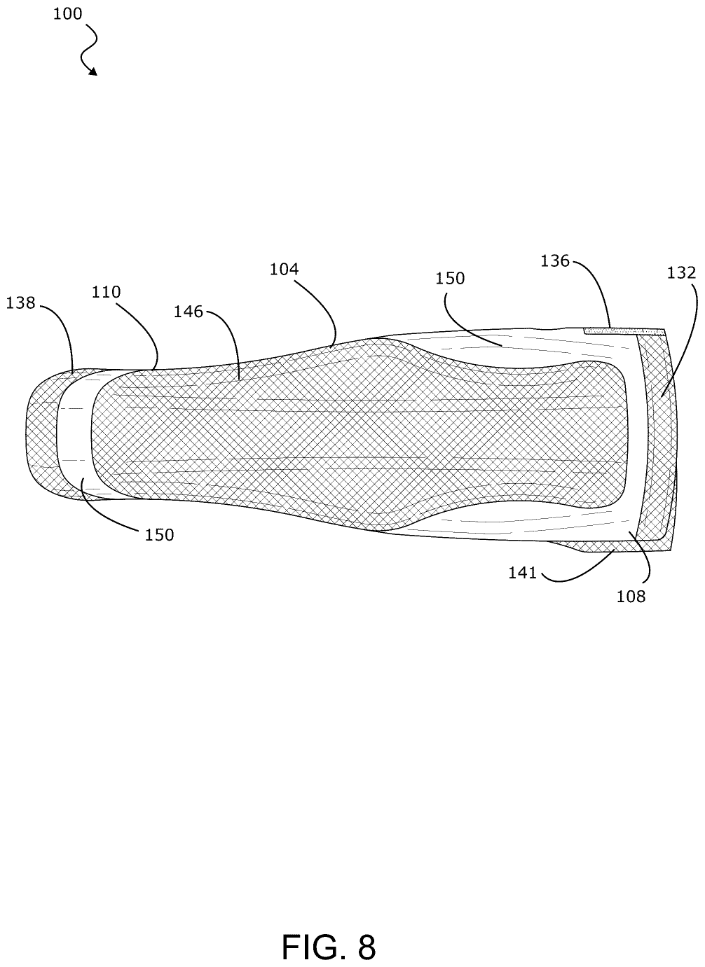

FIG. 8 shows a schematic top view of the ice axe cover 100 in accordance with embodiments of the disclosure. FIG. 8 shows the head section 104, including the pick sleeve 110 and pick sleeve rim 138. FIG. 8 also shows the adze slot 108 and adze slot rim 132. FIG. 8 also shows the head grip component 146 and the reflective component 150. Additionally, FIG. 8 shows the shaft flap 141 and the adze attachment loop component 136.

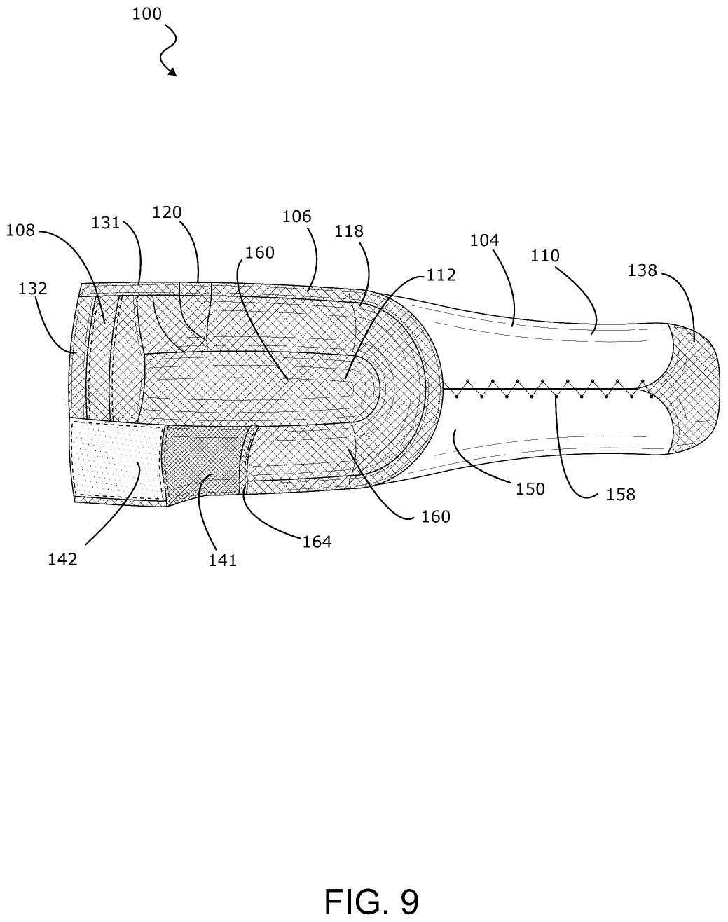

FIG. 9 shows a schematic bottom view of the ice axe cover 100 in accordance with embodiments of the disclosure. FIG. 9 shows the head section 104, including the pick sleeve 110, and the shaft section 106. The head section 104 includes the pick sleeve rim 138.

The pick sleeve 110 includes pick sleeve stitching 158, which is configured to hold edges of a patterned and cut material comprising the body component 160, so as to form the pick sleeve 110 of the ice axe cover 100. The pick sleeve stitching 158 can be configured to connect edges of the body component 160 of the ice axe cover 100. The pick sleeve stitching 158 is shown on a pick sleeve 110 of the ice axe cover 100 on a side of the pick sleeve 110 opposite the head grip 146 of the ice axe cover 100. As shown in FIG. 9, the pick sleeve stitching 158 can be configured to terminate at a pick sleeve rim 138. As shown in FIG. 9, the pick sleeve stitching 158 can be configured extending from the shaft section 106 on the pick sleeve 110 to the pick sleeve rim 138. Although not shown in FIG. 9, the pick sleeve stitching 158 can be configured to extend from the shaft opening 118 of the ice axe cover 100, beneath a shaft grip component (not shown), and terminate at the pick sleeve rim 138.

The head section 104 includes the reflective component 150. FIG. 9 also shows the adze slot 108, the adze slot rim 132, the first adze flap 131, and a portion of the leash notch 120. Additionally, FIG. 9 shows the body component 160 of the head section 104.

FIG. 9 also shows the shaft section 106, The shaft section 106 comprises the body component 160. The shaft section 106 includes the shaft flap 141, which includes the shaft attachment hook component 142. The shaft flap is bonded to the shaft section 106 via the flap connector 164. In some embodiments, the flap connector 164 comprises thread. In some embodiments, the flap connector 164 comprises glue. In some embodiments, the shaft flap 141 comprises the shaft grip component (not shown), and the shaft grip component is sewn and/or bonded to the body component 160 of the shaft section 106. FIG. 9 also shows the shaft opening 118. FIG. 9 shows the shaft junction 112 through the shaft opening 118.

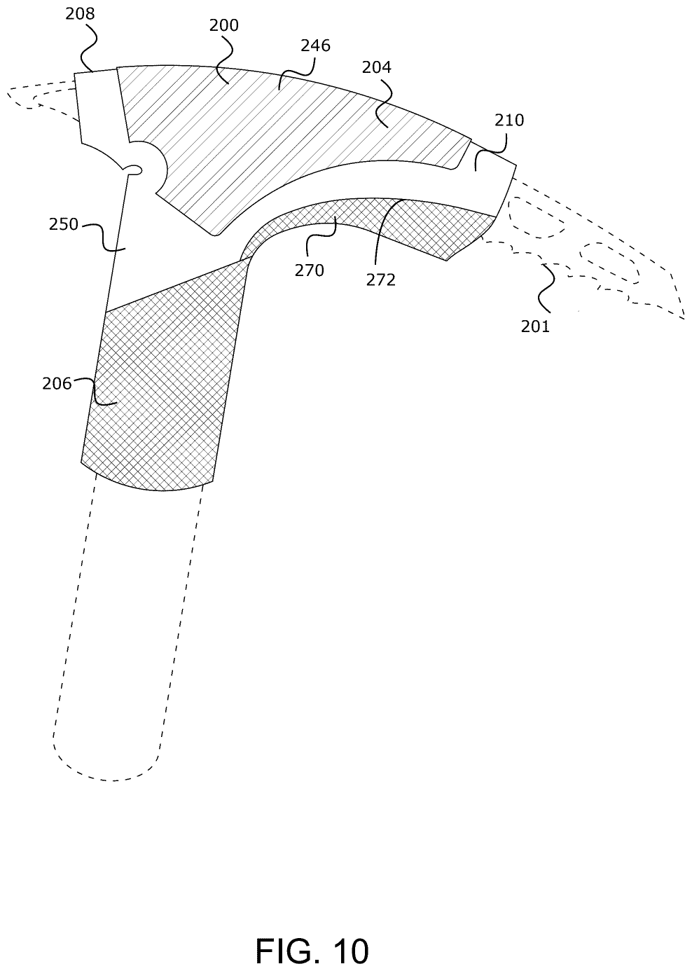

FIG. 10 shows a schematic left side view of an ice cover 200 covering an ice axe 201 in accordance with embodiments of the disclosure. The ice axe cover 200 comprises a head section 204 and a shaft section 206. The head section comprises an adze slot 208 and a pick sleeve 210. The head section 204 and shaft section 206 can comprise a thermally insulative material. For example, in some embodiments, the ice axe cover comprises a layer of Neoprene patterned, cut and sewn to form the ice axe cover 200.

The ice axe cover 100 comprises a head grip component 246. In some embodiments, the head grip component 246 comprises a tactile material, such as Neoprene with raised bumps and/or grooves. The ice axe cover 100 comprises a reflective material 250. In some embodiments, the reflective material 250 comprises a retroreflective material. In some embodiments, the shaft component comprises a tactile material, such as neoprene with raised bumps and/or grooves.

In some embodiments, as shown in FIG. 10, the ice axe cover 101 comprises a pick sleeve finger component 270. The pick sleeve finger component 270 can be configured to receive a finger of a person wrapped around the pick sleeve when a palm of the person is holding the head section 204 of the ice axe cover 200 covering the ice axe 201. In some embodiments, the pick sleeve finger component 270 comprises a tactile material. For example, in some embodiments, the pick sleeve finger component 270 can comprise a layer of neoprene with raised bumps and/or grooves. In some embodiments, the pick sleeve finger component 270 and the shaft section 206 comprise a common material. In some embodiments, the pick sleeve finger component 270 and shaft section 206 comprise a conspicuous material. For example, in some embodiments, the pick sleeve finger component 270 and the shaft section 206 can be painted a color that is conspicuous in the snow, such as bright orange.

In some embodiments, the pick sleeve finger component 270 and the head component comprise two different layers of material, and the pick sleeve finger component 270 is sewn and/or bonded to the head section 204 of the ice axe 100 via a pick sleeve finger component connector 272. One advantage according to embodiments of the disclosure, including the embodiment shown in FIG. 10, is that the pick sleeve does not include a seam under the pick sleeve, where teeth of an ice axe contact the seam. By configuring the ice axe cover 100 with the pick sleeve finger component 270 where the pick sleeve finger component 270 will be adjacent to the pick sleeve 210, the teeth of the pick of the ice axe will not contact the connection between edges of the ice axe cover, such as a seam along the middle of the pick sleeve 210.

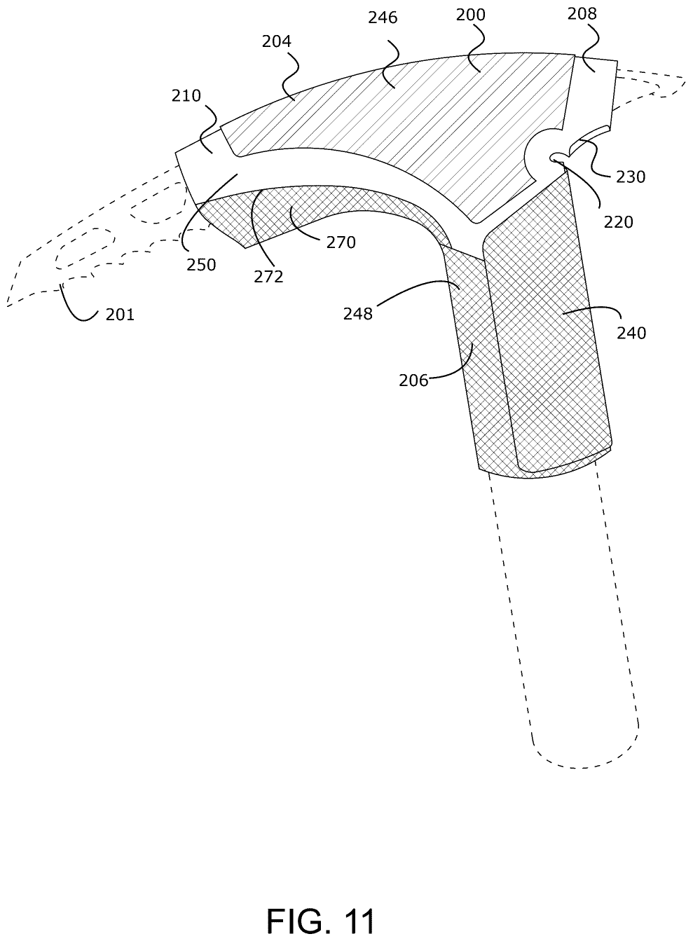

FIG. 11 shows a schematic right side view of the ice axe cover 200 covering the ice axe 201 according to embodiments of the disclosure. The ice axe cover 200 comprise the head section 204 and the shaft section 206. The ice axe cover comprises the pick sleeve 210, the adze slot 208, and a leash notch 220. The ice axe cover comprises the reflective component 250. The ice axe cover also includes a shaft grip component 248. For example, in some embodiments, the shaft grip component 248 comprises neoprene with raised bumps and/or grooves. The ice axe cover 200 also includes a shaft attachment component 240 and an adze attachment component 230. FIG. 11 also shows the pick sleeve finger component 270 and the pick sleeve finger component connector 272. FIG. 11 also shows the head grip component 246 The ice axes covers according to embodiments of the disclosure can be constructed by cutting material in patterns and sewing and/or bonding the material together and to each other to form the ice axe cover. As discussed herein, in some embodiments, an ice axe cover is constructed by patterning and cutting a layer of neoprene, forming a body component of the ice axe cover. Velcro patches and grip material can then be cut in desired shapes and sewn and/or bonded to create the ice axe covers discussed herein.

Cut patterns can be used for cutting material in a desired shape. Cut patterns can include a shaft attachment component pattern, which can be used for cutting material for the shaft attachment component. For example, the shaft attachment component pattern can be used for cutting a shaft attachment hook component out of a hook material, such as a Velcro™ hook panel, and an inverse of the shaft attachment component pattern 202 can be used for cutting the shaft attachment loop component out of a loop material, such as a Velcro™ loop panel.

Cut patterns can also include an adze attachment component pattern, which can be used for cutting material for an adze attachment component. For example, the adze attachment component pattern can be used for cutting the adze attachment hook component out of a hook material, such as a Velcro™ hook panel, and an inverse of the adze attachment component pattern can be used for cutting the adze attachment loop component out of a loop material, such as a Velcro™ loop panel.

Cut patterns can also include a body pattern, which can be used for cutting material for a body component. In some embodiments, the body pattern is used for cutting a thermally insulative material of the ice axe cover. For example, in some embodiments, the body pattern is used for cutting the body component comprising a layer of neoprene.

Cut patterns can also include a shaft grip pattern, which can be used for cutting material for a shaft grip component. For example, the shaft grip pattern can be used for cutting the shaft grip component) comprising a layer of material that includes a tactile component. For example, in some embodiments, the shaft grip component can comprise neoprene that has been configured to comprise a tactile enhanced design, such as texture comprising raised circular features.

Cut patterns can also include a head grip pattern, which can be used for cutting material for a head grip component. For example, in some embodiments, the head grip pattern can be used for cutting the head grip component comprising a layer of material that includes a tactile component. For example, in some embodiments, the head grip component can comprise neoprene that has been configured to comprise a tactile enhanced design, such as texture comprising raised circular features.

Cut patterns can also include a pick sleeve rim pattern, which can be used for cutting material for a pick sleeve rim. For example, in some embodiments, the pick sleeve rim pattern can be used for cutting the pick sleeve rim comprising a layer of material that includes a tactile component. For example, in some embodiments, the pick sleeve rim can comprise neoprene that has been configured to comprise a tactile enhanced design, such as texture comprising raised circular features.

Cut patterns can also include an adze slot rim pattern, which can be used for cutting material for the adze slot rim. For example, in some embodiments, the adze slot rim pattern can be used for cutting the adze slot rim comprising a layer of material that includes a tactile component. For example, in some embodiments, the adze slot rim can comprise neoprene that has been configured to comprise a tactile enhanced design, such as texture comprising raised circular features.

Specific embodiments of the technology have been described above for purposes of illustration. However, various modifications can be made without deviating from the foregoing disclosure. For example, in some embodiments, a pick sleeve of an ice axe cover comprises a pick attachment component, such as a hook and loop fastener, which can be used for securing the ice axe cover to an ice axe via the pick sleeve. Similarly, in some embodiments, an adze slot of an ice axe cover comprises a continuous cylinder without an attachment component. Accordingly, the technology is not limited except as by the appended claims. Furthermore, even if not labeled as such, Figures may not be drawn to scale.

I/We claim:

1. An ice axe cover comprising:
a head section configured to cover at least a portion of a head of an ice axe, wherein the head section comprises:
an adze slot for receiving an adze of the head of the ice axe, the adze slot comprising an adze slot opening, wherein:
the adze slot is configured to cover at least a portion of the adze of the ice axe, and
the adze slot is configured to expose outside the ice axe cover, via the adze slot opening, at least a cutting edge of the adze, and
a pick sleeve for receiving a pick of the head of the ice axe, the pick sleeve comprising extending from the shaft junction of the head section to a pick sleeve opening of the pick sleeve, wherein:
the pick sleeve is configured to cover at least a portion of the pick of the ice axe, and
the pick sleeve is configured to expose outside the ice axe cover, via the pick sleeve opening, at least a tip of the pick; and
a shaft section extending from the shaft junction of the head section to a shaft opening, wherein:
the shaft section is configured to cover at least a portion of a shaft of the ice axe, and
the shaft section is configured to expose outside the ice axe cover, via the shaft opening, at least some of the shaft of the ice axe.

2. The ice axe cover of claim 1, further comprising a leash notch at the shaft junction.

3. The ice axe cover of claim 1, wherein the ice axe cover comprises a thermally insulative material.

4. The ice axe cover of claim 3, wherein the thermally insulative material is neoprene.

5. The ice axe cover of claim 1, further comprising a retroreflective material on an outer surface of the ice axe cover.

6. The ice axe cover of claim 1, further comprising a grip material as an outer surface of at least some of the head section.

7. The ice axe cover of claim 1, wherein the pick sleeve comprises a pick sleeve rim at a terminal end of the pick sleeve, wherein the pick sleeve is configured to collapse toward the shaft junction when pressure is applied to the pick sleeve rim in a direction of the shaft junction.

8. The ice axe cover of claim 1, wherein the adze slot comprises an adze attachment component configured to releasably attach the ice axe cover to the ice axe via the adze of the ice axe.

9. The ice axe cover of claim 1, wherein the shaft section comprises a shaft attachment component for securing the ice axe cover to the ice axe via the shaft of the ice axe.

10. The ice axe cover of claim 1, wherein the adze slot is configured to expose outside the adze opening at least a majority of a blade of the adze of the ice axe.

11. The ice axe cover of claim 1, wherein the shaft section comprises a shaft attachment component configured to releasably attach the ice axe cover to the shaft of the ice axe.

12. An ice axe cover comprising:
an adze slot for receiving an adze of the head of the ice axe, wherein:
the adze slot is configured to cover at least a portion of the adze of the ice axe, and
the adze slot is configured to expose outside the ice axe cover at least a cutting edge of the adze, and
a pick sleeve for receiving a pick of the head of the ice axe, wherein:
the pick sleeve is configured to cover at least a portion of the pick of the ice axe, and
the pick sleeve is configured to expose outside the ice axe cover at least a tip of the pick.

13. The ice axe cover of claim 12, wherein the ice axe cover comprises a pliable thermally insulative material.

14. The ice axe cover of claim 13, wherein the pliable thermally insulative material is neoprene.

15. The ice axe cover of claim 12, further comprising a retroreflective material on an outer surface of the ice axe cover.

16. The ice axe cover of claim 12, further comprising a grip material on an outer surface of at least some of the ice axe.

17. The ice axe cover of claim 12, further comprising:
a reflective material on an outer surface of the ice axe cover;
a grip material on an outer surface of at least some of the ice axe, wherein the grip material has a greater coefficient of friction than the reflective material.

18. The ice axe cover of claim 12, wherein the adze slot comprises an adze attachment component configured to releasably attach the ice axe cover to the ice axe via the adze of the ice axe.

19. The ice axe cover of claim 12, wherein the pick sleeve is configured to collapse toward the shaft junction when pressure is applied to a terminal end of the pick sleeve in a direction of the shaft junction.

20. The ice axe cover of claim 12, further comprising a leash notch configured adjacent to the adze slot.
